(19) United States
(12) Patent Application Publication
(10) Pub. No.: US 2025/0373354 A1
(43) Pub. Date: Dec. 4, 2025

(54) COLORLESS OPTICAL TRANSMISSION FOR WAVELENGTH DIVISION MULTIPLEXING

(71) Applicant: AT&T Intellectual Property I, L.P., Atlanta, GA (US)

(72) Inventors: Ricky Perry, Cumming, GA (US); Stewart Barker, Lucas, TX (US)

(21) Appl. No.: 18/680,067

(22) Filed: May 31, 2024

(51) Int. Cl. H04J 14/02

(52) U.S. Cl. CPC H04J 14/0204

(57) ABSTRACT

A method for colorless optical transmission for wavelength division multiplexing includes receiving, by a processing system of an optical splitter including at least one processor, an incoming optical transmission from a far end optical transceiver, cycling, by the processing system, a tunable wavelength division multiplexing multiplexer through a plurality of potential wavelengths for the incoming optical transmission until a wavelength of the incoming optical transmission is detected, wherein the tunable wavelength division multiplexing multiplexer is positioned between an optical interface of the optical splitter and a receiving optical subassembly of the optical splitter, and isolating, by the processing system, the wavelength of the incoming optical transmission subsequent to the detecting.

The present disclosure relates generally to fiber broadband network infrastructure, and relates more particularly to devices, non-transitory computer-readable media, and methods for colorless optical transmission for wavelength division multiplexing.

### BACKGROUND

The delivery of fiber broadband service to customer sites typically involves the use of dense wavelength division multiplexing (DWDM) transmissions across an optical fiber plant (i.e., a fixed installation housing the fiber optics needed to transmit communications signals between two or more points). DWDM increases the bandwidth of an optical fiber connection by combining data signals from different sources into a single pair of optical fibers, while maintaining separation of the data streams. When sharing a common optical fiber, these DWDM transmissions typically require the deployment of external passive wavelength division multiplexing (WDM) multiplexers/demultiplexers and/or WDM filter components to isolate wavelengths before the optical receivers within the optical modules.

### SUMMARY

In one example, the present disclosure describes a device, computer-readable medium, and method for colorless optical transmission for wavelength division multiplexing. For instance, in one example, a method for colorless optical transmission for wavelength division multiplexing includes receiving, by a processing system of an optical splitter including at least one processor, an incoming optical transmission from a far end optical transceiver, cycling, by the processing system, a tunable wavelength division multiplexing multiplexer through a plurality of potential wavelengths for the incoming optical transmission until a wavelength of the incoming optical transmission is detected, wherein the tunable wavelength division multiplexing multiplexer is positioned between an optical interface of the optical splitter and a receiving optical subassembly of the optical splitter, and isolating, by the processing system, the wavelength of the incoming optical transmission subsequent to the detecting.

In another example, a non-transitory computer-readable medium stores instructions which, when executed by a processing system of an optical splitter including at least one processor, cause the processing system to perform operations. The operations include receiving an incoming optical transmission from a far end optical transceiver, cycling a tunable wavelength division multiplexing multiplexer through a plurality of potential wavelengths for the incoming optical transmission until a wavelength of the incoming optical transmission is detected, wherein a tunable wavelength division multiplexing multiplexer is positioned between an optical interface of the optical splitter and a receiving optical subassembly of the optical splitter, and isolating the wavelength of the incoming optical transmission subsequent to the detecting.

In another example, an apparatus includes an optical interface to receive an optical transmission and an optical transceiver. The optical transceiver includes a tunable wavelength division multiplexing multiplexer to isolate a wavelength of the optical transmission, a receiving optical subassembly to convert the optical transmission to an electrical signal, wherein the tunable wavelength division multiplexing multiplexer is positioned between the optical interface and the receiving optical subassembly, and a transmitting optical subassembly. The apparatus further includes an electrical interface to transmit the electrical signal.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for colorless optical transmission for wavelength division multiplexing may operate;

FIG. 2 illustrates a more detailed view of one example of the first optical splitter and second optical splitter of FIG. 1;

FIG. 3 illustrates a flowchart of an example method for colorless optical transmission for wavelength division multiplexing; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for colorless optical transmission for wavelength division multiplexing. As discussed above, the delivery of fiber broadband service to customer sites typically involves the use of dense wavelength division multiplexing (DWDM) transmissions across an optical fiber plant (i.e., a fixed installation housing the fiber optics needed to transmit communications signals between two or more points). DWDM increases the bandwidth of an optical fiber connection by combining data signals from different sources into a single pair of optical fibers, while maintaining separation of the data streams. When sharing a common optical fiber, these DWDM transmissions typically require the deployment of external passive wavelength division multiplexing (WDM) multiplexers/demultiplexers and/or WDM filter components to isolate wavelengths before the optical receivers within the optical modules. Although this deployment reduces fiber counts, implementation of this deployment also requires complex engineering and deployment skillsets.

Examples of the present disclosure utilize a tunable multiplexer that is integrated into the direct detection optical module on the receive side of a fiber broadband infrastructure. The tunable multiplexer detects the wavelength of an optical carrier from the remote send side of the fiber broadband infrastructure (e.g., from the optical fiber plant), where the wavelength is selected via a fixed or tunable transmission optical subassembly (TOSA). The tunable multiplexer then isolates the transmission wavelength before the carrier enters the optical transmission receiver optical sub-assembly (ROSA). Thus, integration of the tunable multiplexer effectively enables the direct detection optical module to operate as a coherent detect optical module, but without the need for costly digital signal processors (DSPs).

More specifically, the disclosed approach eliminates the need for complex and costly DSPs that are used in conventional fiber broadband infrastructures to extract the amplitude, frequency, and phase information from an optical carrier to isolate the signal. The elimination of the DSPs simplifies the configuration of the optical fiber plant by eliminating the need for external multiplexer/demultiplexers or filters to isolate wavelengths feeding into the ROSA, which in turn allows for the coexistence of multiple wavelengths on the same optical fiber. With an integrated tunable multiplexer in front of the ROSA, the wavelength isolation can be performed within the direct detection optical module rather than externally to the optical module.

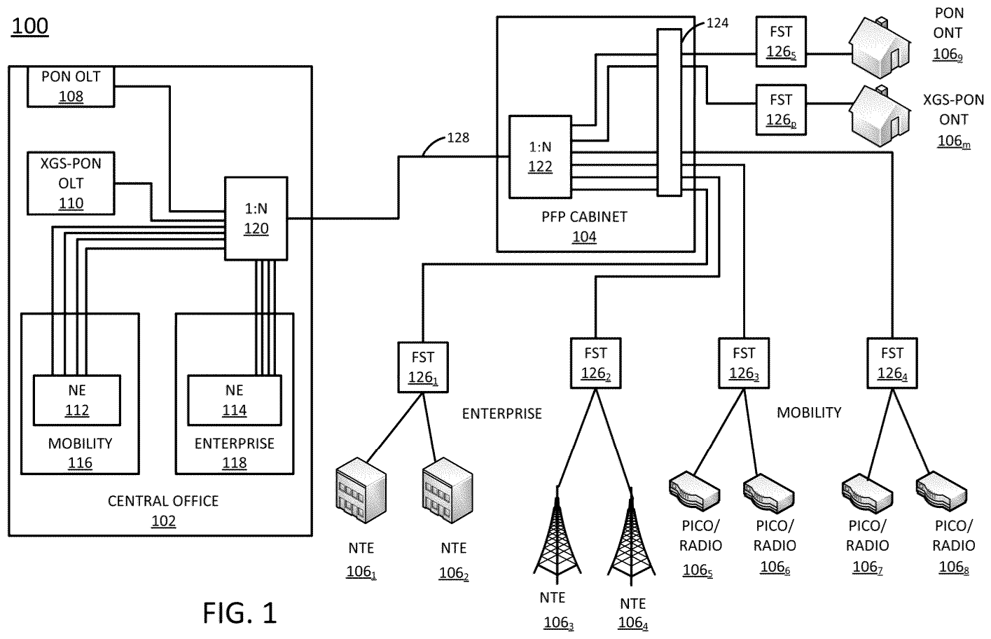

Thus, examples of the present disclosure provide a lower cost component solution to the optical modules needed in the access network of a fiber broadband infrastructure, by eliminating the need for more expensive and sophisticated optical transmission modules such as coherent detection modules. By simplifying the infrastructure outside of the optical fiber plant, the costs for labor, engineering, operations, and troubleshooting of the optical fiber plant can be significantly reduced without degradation of service to fiber broadband customers. These and other aspects of the present disclosure are discussed in further detail with reference to FIGS. 1-4, below.

To further aid in understanding the present disclosure, FIG. 1 illustrates an example system 100 in which examples of the present disclosure for colorless optical transmission for wavelength division multiplexing may operate. The system 100 may comprise at least a portion of an optical distribution network (ODN). In one example, the system 100 generally comprises a send side comprising a central office (or head end) 102 and a receive side comprising a primary flexibility point (PFP) cabinet 104 and a plurality of customer sites 106₁-106ₘ (hereinafter individually referred to as a “customer site 106” or collectively referred to as “customer sites 106”).

The central office 102 comprises a hub or centrally located point in the system 100 at which a conglomerate signal is distributed to optical nodes (e.g., in neighborhoods or premise locations). The conglomerate signal may carry voice, data, and/or video services to the customer sites 106. In one example, the central office 102 may include one or more optical line terminals (OLTs) 108 and 110. The OLTs 108 and 110 comprise the starting points of fiber optic access networks, such as a 25 G or 50 G passive optical network (PON) or a higher speed XGS-PON. The central office 102 may further include one or more network elements (NEs) 112 and 114 supporting one or more service networks, such as a mobility network 116, an enterprise network 118, or another type of service network.

The OLTs 108 and 110, as well as the NEs 112 and 114, may all be connected (e.g., via Ethernet cables) to a first optical splitter 120. The first optical splitter 120 may be a 1:N optical splitter that is capable of receiving up to N transmission signals (e.g., from the OLTs 108 and 110 and the NEs 112 and 114) and converging the N transmission signals onto a single backbone feeder fiber 128.

The disclosed arrangement differs from a conventional WDM architecture, in which the transmission signals from the NEs 112 and 114 would typically be processed by filters and multiplexers which would receive as input multiple signals of different wavelengths (e.g., colors) and combine those multiple signals into a single combined signal containing all of the multiple wavelengths. For instance, each NE 112 or 114 could output its respective transmission signals to one or more filter/multiplexer combinations to produce one or more combined signals. The combined signals would then be input (along with respective transmission signals from OLTs 108 and 110) to a single fiber combining module (e.g., another multiplexer) that would separate the individual wavelengths out from the combined signals before outputting selected individual wavelengths onto the backbone feeder fiber 128.

As discussed above, however, examples of the present disclosure replace the single fiber combining module with the first optical splitter 120, which allows the NEs 112 and 114 to output their transmission signals directly to the first optical splitter 120, i.e., without those transmission signals having to be combined into a single combined signal by a filter/multiplexer combination. The first optical splitter 120 can therefore output the conglomerate signal (comprising the transmission signals from the OLTs 108 and 110 and the NEs 112 and 114, which may be of multiple different wavelengths) via the backbone feeder fiber 128.

On the receive side, the cabinet 104 comprises an enclosure which houses a second optical splitter 122 and a distribution fiber cable termination panel 124. In one example, the second optical splitter 122 is a 1:N optical splitter that receives (via the backbone feeder fiber 128) the conglomerate signal that is output by the first optical splitter 120 in the central office 102. The second optical splitter 122 separates the single conglomerate signal into up to N individual signals of different wavelengths (e.g., one wavelength or range of wavelengths per individual signal) and delivers the up to N individual signals to the distribution fiber cable termination panel 124 for distribution to the customer sites 106.

From the distribution fiber cable termination panel 124, the up to N individual signals may be delivered to a plurality of flexible service (or fiber drop) terminals 126₁-126ₚ (hereinafter individually referred to as an “FST 126” or collectively referred to as “FSTs 126”). In one example, each FST 126 is associated with one or more customer sites 106, such as homes, offices, cellular base stations (e.g., eNodeBs in long term evolution networks or gNodeBs in fifth generation networks) and other network termination equipment (NTE), radio nodes and sensors (e.g., picoradio nodes), and other customer sites. Thus, each signal of the up to N individual signals may be routed via the distribution fiber cable termination panel 124 to the FST 126 associated with the customer site 106 that is the destination for the signal. Each of the up to N individual signals may be presented via one or more native service interfaces to users at the customer sites 106. These services may include voice (e.g., plain old telephone service, voice over Internet Protocol, etc.), data (e.g., Ethernet, V.35, etc.), video, and/or telemetry services.

In a conventional WDM architecture such as that discussed above, an external multiplexer (i.e., external to the cabinet 104) would typically be required to separate the conglomerate signal into the individual signals prior to the individual signals entering the cabinet 104. If the external multiplexer was implemented as a coherent detection optical module, then the optical module would typically require a DSP in order to extract the amplitude, frequency, and phase information from the conglomerate signal. Likewise, a DSP would typically also be required on the send side, e.g., in the optical module that includes the single fiber combining module. The DSPs would allow tuning to very precise wavelengths on both the transmit and receive sides. If the external multiplexer was integrated as a simpler direct detection optical module (without A DSP), then the external multiplexer would typically receive all wavelengths as there would be no tuning (and no DSP) on the transmit side.

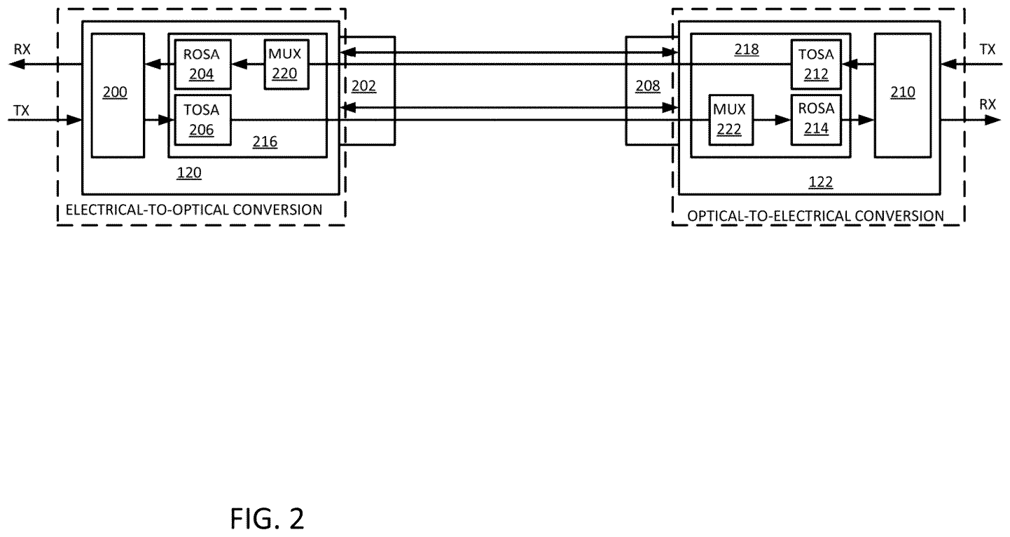

In examples of the present disclosure, both the first optical splitter 120 and the second optical splitter 122 may be implemented as direct detection optical modules that include a tunable filter. FIG. 2, for instance, illustrates a more detailed view of one example of the first optical splitter 120 and second optical splitter 122 of FIG. 1.

In one example, the first optical splitter 120 is configured to convert electrical signals (e.g., received from the OLTs 108 and 110 and NEs 112 and 114) into optical signals for transmission over the backbone feeder fiber 128, while the second optical splitter 122 is configured to convert the optical signal received over the backbone feeder fiber 128 back into electrical signals for distribution to equipment at the customer sites 106.

Thus, in one example, the first optical splitter 120 generally comprises an electrical interface 200 that can receive and transmit electrical signals (RX and TX, respectively) as well as an optical interface 202 that can receive and transmit optical signals. Between the electrical interface 200 and the optical interface 202 is a first transceiver module 216. The first transceiver module 216 generally comprises a first ROSA 204, a first TOSA 206, and a first WDM multiplexer 220.

In one example, the first ROSA 204 comprises a broadband receiver that is capable of receiving optical transmissions of any wavelength and converting those optical transmissions into electrical signals. The first WDM multiplexer 220 is positioned before the first ROSA 204 on the receive path into the first optical splitter 120 (i.e., between the optical interface 202 and the first ROSA 204). In one example, the first WDM multiplexer 220 is a tunable WDM multiplexer that is tuned to a wavelength being transmitted by a transmitting TOSA (e.g., TOSA 212 of the second optical splitter 122, discussed in greater detail below). The first WDM multiplexer 220 may be capable of automatically self-tuning to the wavelength that is being transmitted.

For instance, in one example, the first WDM multiplexer 220 may draw power from the power supply of the first optical splitter 120. This would allow the first WDM multiplexer 220 to cycle through a plurality of wavelengths and to measure or sense the wavelength of the incoming optical transmission. Cycling through the wavelengths may be performed in any one or more of a number of ways. For instance, the first WDM multiplexer 220 may be programmed to cycle through a predetermined spectrum of wavelengths bounding a predetermined starting wavelength and a predetermined stopping wavelength. The first WDM multiplexer 220 may then be tuned across the predetermined spectrum (starting with the predetermined starting wavelength) until the optimal signal level is archived. The first WDM multiplexer 220 may begin the tuning scan on power-up. In another example, the first WDM multiplexer 220 may be provisioned with a predetermined wavelength to which to tune.

Once the wavelength of the incoming optical transmission is detected, the first WDM multiplexer 220 may lock onto the detected wavelength, such that the optical power of the signal entering the first ROSA 204 will only be on the detected wavelength, i.e., the wavelength being transmitted from the transmitting TOSA. The transmission of the detected wavelength may then be forwarded to the first ROSA 204 for conversion to an electrical signal.

The first TOSA 206 may comprise either a fixed or a tunable TOSA. The first TOSA 206 converts electrical signals into optical transmissions of a selected wavelength for transmission to the second optical splitter 122.

The second optical splitter 122 similarly comprises an optical interface 208 that can receive and transmit optical signals and an electrical interface 210 that can receive and transmit electrical signals (RX and TX, respectively). Between the electrical interface 210 and the optical interface 208 is a second transceiver module 218. The second transceiver module 218 generally comprises a second ROSA 214, a second TOSA 212, and a second WDM multiplexer 222.

In one example, the second ROSA 214 comprises a broadband receiver that is capable of receiving optical transmissions of any wavelength and converting those optical transmissions into electrical signals. The second WDM multiplexer 222 is positioned before the second ROSA 214 on the receive path into the second optical splitter 122 (i.e., between the optical interface 208 and the second ROSA 214). In one example, the second WDM multiplexer 222 is a tunable WDM multiplexer that is tuned to a wavelength being transmitted by a transmitting TOSA (e.g., first TOSA 206 of the first optical splitter 120). The second WDM multiplexer 222 may be capable of automatically self-tuning to the wavelength that is being transmitted.

For instance, in one example, the second WDM multiplexer 222 may draw power from the power supply of the second optical splitter 122. This would allow the second WDM multiplexer 222 to cycle through a plurality of wavelengths and to measure or sense the wavelength of the incoming optical transmission. Once the wavelength of the incoming optical transmission is detected, the second WDM multiplexer 222 may lock onto the detected wavelength, such that the optical power of the signal entering the second ROSA 214 will only be on the detected wavelength, i.e., the wavelength being transmitted from the transmitting TOSA. The transmission of the detected wavelength may then be forwarded to the second ROSA 214 for conversion to an electrical signal.

The second TOSA 212 may comprise either a fixed or a tunable TOSA. The second TOSA 212 converts electrical signals into optical transmissions of a selected wavelength for transmission to the first optical splitter 120.

Thus, both the first optical splitter 120 and the second optical splitter 122 are generally configured as direct detection optical modules, except for the addition of the tunable WDM multiplexers 220 and 222 that are positioned before the respective ROSAs 204 and 214 on the respective receive paths. The addition of the WDM multiplexers 220 and 222 allow the first optical splitter 120 and the second optical splitter 122 to become “colorless” in the sense that no DSPs or external multiplexers or filters are required.

It should be noted that the system 100 has been simplified. Thus, those skilled in the art will realize that the system 100 may be implemented in a different form than that which is illustrated in FIG. 1, or may be expanded by including additional endpoint devices, access networks, network elements, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. Moreover, those skilled in the art will realize that the optical splitters 120 and 122 which are further illustrated in FIG. 2 may be implemented in a different form than that which is illustrated in FIG. 1, or may include additional components such as processors, memory, non-transitory computer-readable media, and the like, etc. without altering the scope of the present disclosure.

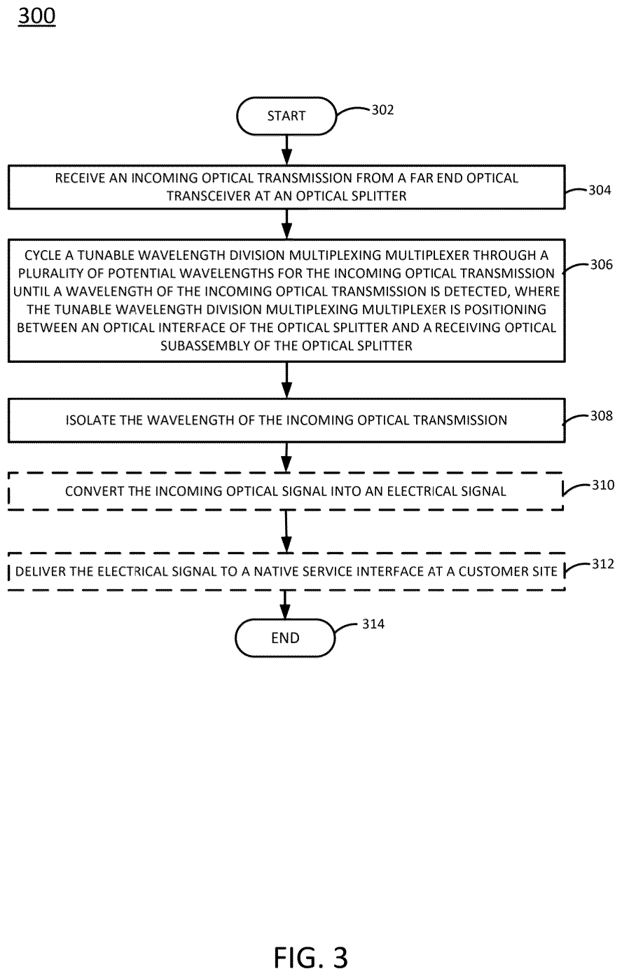

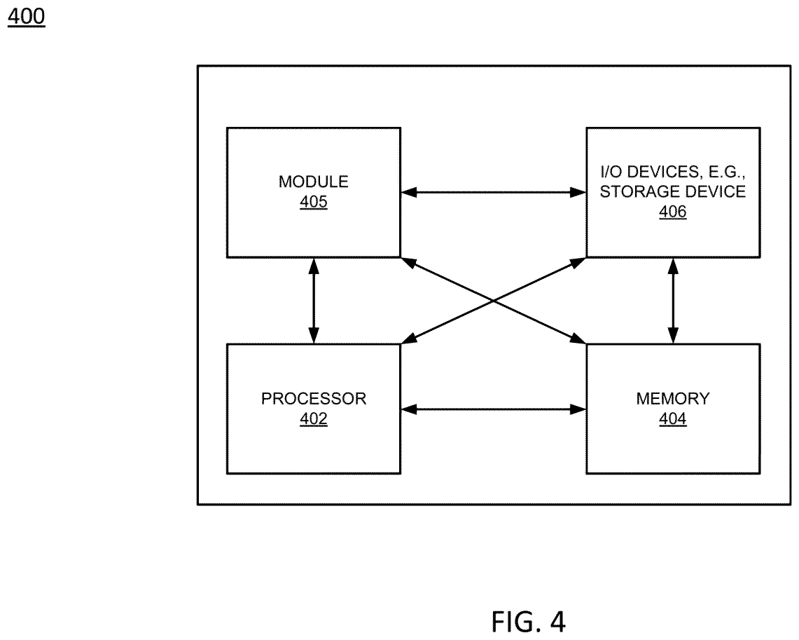

To further aid in understanding the present disclosure, FIG. 3 illustrates a flowchart of an example method 300 for colorless optical transmission for wavelength division multiplexing. In one example, the method 300 may be performed by one of the optical splitters 120 or 122 illustrated in FIG. 1, or one or more components of the optical splitters 120 or 122 (such as processors, ROSA, multiplexers, or the like). However, in other examples, the method 300 may be performed by another device, such as the computing system 400 of FIG. 4, discussed in further detail below. For the sake of discussion, the method 300 is described below as being performed by a processing system (where the processing system may comprise a component of an optical splitter 120 or 122, the computing system 400, or another device).

The method 300 begins in step 302. In step 304, the processing system may receive an incoming optical transmission from a far end optical transceiver.

In one example, the processing system may be part of an optical splitter (also referred to as a “second optical splitter”) that resides within a PFP cabinet of an optical distribution network. In another example, the processing system may be part of an optical splitter that is spliced into the fiber plant (i.e., without the need for a PFP cabinet). The second optical splitter may comprise a 1:N optical splitter. The far end transceiver may be part of another optical splitter (also referred to as a “first optical splitter”) that resides within a central office of the optical distribution network. The first optical splitter may also comprise a 1:N optical splitter.

In step 306, the processing system may cycle a tunable wavelength division multiplexing multiplexer through a plurality of potential wavelengths for the incoming optical transmission until a wavelength of the incoming optical transmission is detected, wherein the tunable wavelength division multiplexing multiplexer is positioned between an optical interface of the optical splitter and a receiving optical subassembly of the optical splitter.

In one example, the processing system may control a tunable WDM multiplexer of the second optical splitter to cycle through the plurality of wavelengths and to detect the wavelength of the optical transmission. In one example, the tunable WDM multiplexer is positioned before a receiving optical subassembly (ROSA) of the second optical splitter on the receive path. In other words, the tunable WDM multiplexer may be positioned between an optical interface of the second optical splitter (via which the incoming optical transmission is received by the second optical splitter) and the ROSA of the second optical splitter.

In step 308, the processing system may isolate the wavelength of the incoming optical transmission subsequent to the detecting. As discussed above, the tunable WDM multiplexer of the second optical splitter may be positioned between the second optical splitter's optical interface and transceiver/ROSA. This allows the wavelength of the incoming optical transmission to be isolated before the incoming optical transmission enters the ROSA, without requiring the isolation to be performed by an external multiplexer (i.e., external to the second optical splitter and/or the PFP cabinet) or a digital signal processor. In one example, the tunable WDM multiplexer may be self-tuning (i.e., capable of automatically self-tuning to the wavelength of the incoming optical transmission). Thus, the outside fiber plant infrastructure is simplified (which reduces costs for labor, engineering, operations, and troubleshooting) without significantly increasing the cost or complexity of the internal infrastructure.

In optional step 310 (illustrated in phantom), the processing system may convert the incoming optical transmission into an electrical signal. In one example, the processing system may control the ROSA to perform the conversion of the incoming optical transmission (whose wavelength has been isolated prior to entering the ROSA) to the electrical signal.

In optional step 312 (illustrated in phantom), the processing system may deliver the electrical signal to a native service interface at a customer site. In one example, the customer site may comprise, for instance, a home, an office, a cellular base station (e.g., an eNodeB in a long term evolution network or a gNodeB in a fifth generation network) or other network termination equipment (NTE), a radio node or sensor (e.g., a picoradio node), or another type of customer site. The native service may comprise, for instance, a voice (e.g., plain old telephone service, voice over Internet Protocol, etc.), data (e.g., Ethernet, V.35, etc.), video, and/or telemetry service.

In step 314, the method 300 may end.

Although not expressly specified above, one or more steps of the method 300 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

Moreover, it should be noted that when the terms “first,” “second,” “third,” or the like are used herein to refer to items (such as a “transceiver,” an “optical splitter,” a “ROSA/TOSA,” a “tunable WDM multiplexer,” or the like), these terms are meant only to differentiate between two or more different items of the same type. In other words, such terms are not necessarily meant to imply that a particular number of items exists or is required for operation of the present disclosure. Nor is a reference to a “second,” “third,” or the like item meant to imply that a “first,” “second,” or the like item exists or is required. Similarly, the term “1: N” may be alternatively referred to as “N: 1” depending on the direction and the number of signals entering (input) and leaving (output) a module, e.g., a splitter. Generally, the terms “1:N” and “N:1” can be used interchangeably.

FIG. 4 depicts a high-level block diagram of a computing device specifically programmed to perform the functions described herein. For example, any one or more components or devices illustrated in FIG. 1 or FIG. 2 or described in connection with the method 300 may be implemented as the system 400. For instance, one of the optical splitters 120 or 122 of FIGS. 1 and 2 (such as might be used to perform the method 300) could be implemented as illustrated in FIG. 4.

As depicted in FIG. 4, the system 400 comprises a hardware processor element 402, a memory 404, a module 405 for colorless optical transmission for wavelength division multiplexing, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for colorless optical transmission for wavelength division multiplexing may include circuitry and/or logic for performing special purpose functions relating to detecting and isolating wavelengths of optical transmissions. The input/output devices 406 may include, for example, storage devices (including but not limited to, a tape drive, a floppy drive, a hard disk drive or a compact disk drive), a receiver, a transmitter, a transceiver, an electrical interface, an optical interface, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for colorless optical transmission for wavelength division multiplexing (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for colorless optical transmission for wavelength division multiplexing (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above- described example examples, but should be defined only in accordance with the following claims and their equivalents.

What is claimed is:

1. A method comprising:
receiving, by a processing system of an optical splitter including at least one processor, an incoming optical transmission from a far end optical transceiver;
cycling, by the processing system, a tunable wavelength division multiplexing multiplexer through a plurality of potential wavelengths for the incoming optical transmission until a wavelength of the incoming optical transmission is detected, wherein the tunable wavelength division multiplexing multiplexer is positioned between an optical interface of the optical splitter and a receiving optical subassembly of the optical splitter; and
isolating, by the processing system, the wavelength of the incoming optical transmission subsequent to the detecting.

2. The method of claim 1, wherein the optical splitter is a 1:N optical splitter.

3. The method of claim 1, wherein optical splitter resides within a primary flexibility point cabinet of an optical distribution network.

4. The method of claim 3, wherein the far end optical transceiver is part of another optical splitter that resides within a central office of the optical distribution network.

5. The method of claim 4, wherein the another optical splitter is a 1:N optical splitter.

6. The method of claim 3, wherein the wavelength of the incoming optical transmission is isolated within the optical splitter before the incoming optical transmission enters the receiving optical subassembly of the optical splitter.

7. The method of claim 1, wherein the tunable wavelength division multiplexing multiplexer is programmed to self-tune by scanning through a predetermined spectrum of wavelengths comprising the plurality of potential wavelengths.

8. The method of claim 1, further comprising:
converting, by the processing system, the incoming optical transmission into an electrical signal; and
delivering the electrical signal to a native service interface at a customer site.

9. The method of claim 8, wherein the electrical signal is delivered via an electrical interface of the optical splitter.

10. A non-transitory computer-readable medium storing instructions which, when executed by a processing system of an optical splitter including at least one processor, cause the processing system to perform operations, the operations comprising:
receiving an incoming optical transmission from a far end optical transceiver;
cycling through a plurality of potential wavelengths for the incoming optical transmission until a wavelength of the incoming optical transmission is detected, wherein a tunable wavelength division multiplexing multiplexer is positioned between an optical interface of the optical splitter and a receiving optical subassembly of the optical splitter; and
isolating the wavelength of the incoming optical transmission subsequent to the detecting.

11. The non-transitory computer-readable medium of claim 10, wherein the wavelength of the incoming optical transmission is isolated within the optical splitter before the incoming optical transmission enters the receiving optical subassembly of the optical splitter.

12. The non-transitory computer-readable medium of claim 10, further comprising:
converting, by the processing system, the incoming optical transmission into an electrical signal; and
delivering the electrical signal to a native service interface at a customer site.

13. An apparatus comprising:
an optical interface to receive an optical transmission;
an optical transceiver, the optical transceiver comprising:
a tunable wavelength division multiplexing multiplexer to isolate a wavelength of the optical transmission;
a receiving optical subassembly to convert the optical transmission to an electrical signal, wherein the tunable wavelength division multiplexing multiplexer is positioned between the optical interface and the receiving optical subassembly; and
a transmitting optical subassembly; and
an electrical interface to transmit the electrical signal.

14. The apparatus of claim 13, wherein the apparatus comprises an optical splitter.

15. The apparatus of claim 14, wherein the optical splitter is a 1:N optical splitter.

16. The apparatus of claim 14, wherein the optical splitter resides within a primary flexibility point cabinet of an optical distribution network.

17. The apparatus of claim 16, wherein the optical transmission is received from a far end transceiver that is part of another optical splitter that resides within a central office of the optical distribution network.

18. The apparatus of claim 17, wherein the another optical splitter is a 1:N optical splitter.

19. The apparatus of claim 16, wherein the tunable wavelength division multiplexing multiplexer is positioned to isolate the wavelength of the optical transmission within the apparatus before the optical transmission enters the receiving optical subassembly of the optical splitter.

20. The apparatus of claim 13, wherein the tunable wavelength division multiplexing multiplexer is self-tuning.
